(19) United States
(12) Patent Application Publication
(10) Pub. No.: US 2006/0089975 A1
(43) Pub. Date: Apr. 27, 2006

(54) Online system recovery system, method and program

(75) Inventor: Koji Iwamoto, Yokohama (JP)

Correspondence Address: MCDERMOTT WILL & EMERY LLP, 600 13TH STREET, N.W., WASHINGTON, DC, 20005-3096, US

(73) Assignees: HITACHI, LTD., Tokyo (JP); Hitachi Software Engineering Co., Ltd., Yokohama (JP)

(21) Appl. No.: 11/282,717

(22) Filed: Nov. 21, 2005

Related U.S. Application Data
(63) Continuation of application No. 10/012,437, filed on Dec. 12, 2001.

(30) Foreign Application Priority Data
Dec. 15, 2000 (JP) 2000-381623

(51) Int. Cl. G06F 15/167

(52) U.S. Cl. 709/213

(57) ABSTRACT

An online system recovery method to address an error in an active online system, involves changeover to a stand-by online system to continue operation. Log information indicative of a history of a reference operation carried out in the active online system and log information indicative of a history of an update operation are transferred to the stand-by online system. The method also includes performing a tracing operation to make contents of an I/O buffer in the stand-by online system coincide with contents of an I/O buffer in the active online system according to the transferred log information. An operating state of the active online system executing a transaction operation is monitored. Upon detecting an error in the active online system, the stand-by online system continues the transaction operation using the contents of its I/O buffer.

### RELATED APPLICATION

This application is a continuation of U.S. application Ser. No. 10/012,437 filed Dec. 21, 2001.

### TECHNICAL FIELD

The present subject matter relates to a high-speed recovering operation for an online processing system and more particularly, to a recovery technique which can be effectively applied to an online processing system such as an online database system where a lot of update transactions take place.

### BACKGROUND

In a conventional general method to facilitate recovery when an active online system is stopped by an error, log information containing history information necessary for system recovery is previously stored in a log file on an external storage in the active online system. When an error takes place in the active online system, a stand-by online system reads out the log information and executes necessary operations.

A technique for speeding-up such a recovery is known, as disclosed in, e.g., JP-A-62-57030. In the disclosed technique, a stand-by online system reads out log information on an external storage shared by host computers, prior to generation of an error; and it traces operation prior to a system down time of an active online system. This reduces the amount of log information to be read out when the error actually occurs.

As disclosed in JP-A-2-77943, it is also known that log information is stored in a log file, both on an external storage shared by host computers in an active online system and also stored in an extension storage shared by the host computers. Then, in a system recovery operation by a stand-by online system after an error in the active online system, the stand-by system reads the log information from the extension storage, thereby avoiding the need to read the log information from the external storage.

As disclosed in JP-A-10-49418, a method is also known wherein a log file of an active online system is transferred to a stand-by online system via communication line. Hence, before a changeover due to an error, a stand-by online system performs a tracing operation. This speeds up the system recovery after an error occurs.

In the technique disclosed in JP-A-62-57030, however, after occurrence of a changeover to the stand-by online system caused by the error, it is necessary to input the log information subsequent to a checkpoint from the log file on the extension storage. Thus, the system must read an enormous amount of log information depending on the checkpoint interval, which results in a major cause of blocking realization of high-speed system recovery. The checkpoint interval may be made narrow, in order to reduce the amount of log information to be read after occurrence of the changeover caused by the error. However, the narrowing of the checkpoint interval will increase the overhead of the active online system.

The technique disclosed in JP-A-2-77943 can increase the reading speed of the log information, but, as in the technique disclosed in JP-A-62-57030, it requires reading of log information subsequent to a checkpoint after occurrence of a changeover to the stand-by online system caused by an error. The system must read an enormous amount of log information depending on the checkpoint interval, which leads to a major cause of blocking realization of high-speed system recovery. Reducing the checkpoint interval to reduce the amount of log information after occurrence of the changeover due to the error leads to another problem with increased overhead for the active online system.

In the technique disclosed in JP-A-10-49418, the log information of the active online system is transferred to the stand-by online system via communication line so that the stand-by online system performs a tracing operation prior to changeover caused by the error. However, because the tracing is carried out with only the log information of an update history, a result of a reference operation such as a reference to an index by the active online system cannot be reflected on the storage of the stand-by online system. Thus when the changeover caused by the error occurs, the efficiency of the reference operation such as the index search will be disadvantageously decreased. Further, there is a problem in that, since the external storage of the log file, database, etc. is not shared, the external storage must have a capacity corresponding to twice the capacity of the unshared external storage. In addition, once redundant configuration collapses due to an error in the stand-by online system, it is necessary to temporarily stop the execution of a transaction to recover the redundant configuration. For this reason, there is a problem that the system cannot operate continuously for 24 hours and 365 days.

### SUMMARY OF THE INVENTION

It is therefore an object of the present invention to provide a technique which can solve the above problems in the prior art and can change an active online system to a stand-by online system at a high speed when an error occurs in the active online system.

Another object of the present invention is to provide a technique which can lighten a transfer load of log information to conform contents of an I/o buffer within a stand-by online system with contents of an I/O buffer within an active online system.

A further object of the present invention is to provide a technique which, when a stand-by online system resumes operation after error occurrence or maintenance, can reestablish a hot standby state without affecting execution of transaction operation of an active online system.

In accordance with an online processing system of the present invention, when an error occurs in an active online system, a stand-by online system continuously performs a transaction operation of the active online system by changing the active online system to status over the previously stand-by online system. That is, when the error occurs in the active online system, since contents of an I/O buffer of the active online system have previously been made to coincide with contents of an I/O buffer of the stand-by online system, the stand-by online system can continuously perform the transaction operation using the I/O buffer of the stand-by online system.

In accordance with the present invention, log information about a reference history indicative of a history of reference operation and about an update history indicative of a history of update operation carried out in an active online system during operation of the active system is transferred to a stand-by online system. The stand-by online system, when receiving the log information, performs operations corresponding to the reference and update operations carried out in the I/O buffer of the active online system using the I/O buffer of the stand-by online system on the basis of the transferred log information. In other words, the contents of the I/O buffer of the stand-by online system is made to coincide with the contents of the I/O buffer of the active online system. In this way, the stand-by online system performs a tracing operation.

Further, the stand-by online system monitors an operating state of the active online system during tracing operation of the active system. Upon detecting an error in the active system, the stand-by online system continues the tracing operation with use of the I/O buffer after being subjected to the tracing operation. In accordance with the present invention, as mentioned above, there can be implemented a method for recovering an online system with an active online system having a small overhead, while eliminating the need for input of log information from a log file on an external storage after an error causes change over to a stand-by online system.

As has been mentioned above, in the online processing system of the present invention, when an error was generated in an active online system, the transaction operation of the stand-by online system can be continued with use of the I/O buffer of the stand-by online system, the contents of which were previously made to coincide with the contents Of the I/O buffer of the active online system. Thus it is possible, when an error occurs in the active online system, to change over to the stand-by online system at a high speed.

### BRIEF DESCRIPTION OF THE DRAWINGS

FIG. 1 shows an example of an arrangement of an online processing system, with active and standby systems;

FIG. 2 is a flowchart for explaining an example of a processing procedure of an active online system and a stand-by online system 22;

FIG. 3 is a flowchart for explaining an example of a processing procedure of business transaction operation;

FIG. 4 is a flowchart for explaining an example of a processing procedure of buffering operation of log information

FIG. 5 is a flowchart for explaining an example of a processing procedure of forced output operation of a not-outputted log; and

FIG. 6 is a flowchart for explaining an example of a processing procedure of a tracing operation

### DETAILED DESCRIPTION

Explanation will be made as to an online processing system in accordance with an embodiment of the invention wherein, when an error occurs in an active online system while performing a transaction operation. Recovery involves changeover to a stand-by online system to continue the transaction operation.

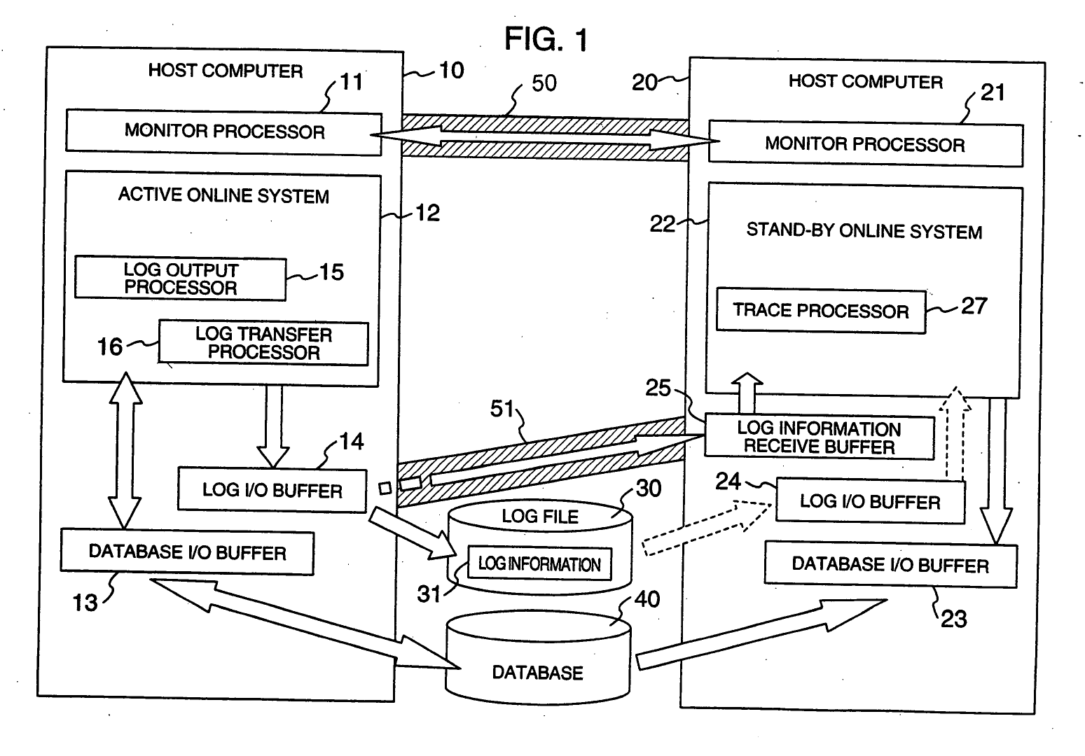

FIG. 1 shows a schematic arrangement of an online processing system in accordance with an embodiment of the invention. As shown in FIG. 1, a host computer 10 in the present embodiment has a monitor processor 11, a log output processor 15 and a log transfer processor 16.

The monitor processor 11 monitors the operating state of a party system by exchanging a control message for mutual monitoring with a monitor processor 21 of the party system to monitor the party system. The log output processor 15 is used to output log information stored in a log I/O buffer 14 to a storage shared by the active online system 12 and the stand-by online system 22.

The log information includes information related to a reference history indicative of a history of reference operation carried out by the active online system 12 and information about an update history indicative of a history of update operation. The log transfer processor 16 is provided to transfer that log information to the stand-by online system 22.

It is assumed that a program to cause the host computer 10 to implement the functions of the various processors 15 is recorded in a recording medium such as CD-ROM and stored in a magnetic disk or the like, and then loaded in a memory for its execution by the computer. In this connection, the recording medium for recording of the program may be a recording medium other than CD-ROM. Hence, examples of computer readable media that may carry or otherwise embody the program instructions include the recording medium as well as the storage and memory in the host computer 10.

A host computer 20 has a monitor processor 21 and a trace processor 27. The monitor processor 21 acts to exchange a control message for mutual monitoring between the monitor processors 21 and 11 to monitor the operating state of the active online system 12 now executing a transaction operation. When the monitor processor 21 detects an error in the active online system 12, the monitor processor 21 causes the stand-by online system 22 to continue the transaction operation by using a database I/O buffer 23 subjected to the tracing operation.

The trace processor 27 performs the tracing operation, making the contents of the database I/O buffer 23 in the stand-by online system 22 coincide with the contents of the database I/O buffer 13 in the active online system 12, according to the transferred log information.

It is assumed that a program for causing the host computer 20 to implement the functions of the various processors is recorded in a recording medium such as CD-ROM, stored in a magnetic disk or the like, and then loaded in a memory for its execution by that computer. In this connection, the recording medium for recording of the program may be a recording medium other than CD-ROM. Hence, examples of computer readable media that may carry or otherwise embody this second program include the recording medium as well as the storage and memory of the host computer 20.

The online processing system of the present embodiment includes a host computer 10 on an active online side, the monitor processor 11 on the active online side, the active online system 12 (e.g., database management system) on the active online side, the host computer 20 on a stand-by online side, the monitor processor 21 on the stand-by online side, and the stand-by online system 22 (e.g., database management system) on the stand-by online side.

A log file 30 or a database 40 is provided on a nonvolatile storage (generally, a magnetic disk unit), which is shared by the active online system 12 on the active online side and the stand-by online system 22 on the stand-by online side.

A database I/O buffer 13 is used by the active online system 12 for record input/output, and the log I/O buffer 14 to be used by the active online system 12 for input/output of the log information to/from the log file 30. A database I/O buffer 23 is used by the stand-by online system 22 for record input/output to/from the database 40, and a log I/O buffer 24 is used by the stand-by online system 22 for input/output of the log information to/from the log file 30.

The active online system 12 further includes the log output processor 15 for outputting the log information stored in the log I/O buffer 14 to the log file 30, and the log transfer processor 16 for transferring the log information stored in the log I/O buffer 14 to a log information receive buffer 25 of the stand-by online system 22. The stand-by online system 22 includes the trace processor 27 for performing the tracing operation of the stand-by system concurrently with the tracing operation of the active online system 12 according to the transferred log information. A communication medium 50 enables exchange of a control message (alive message) for mutual monitoring between the monitor processors 11 and 21. A communication medium 51 is provided for transfer of the log information from the active online system 12 to the stand-by online system 22. The log I/O buffer 24 is provided to input log information 31 on the log file 30 in the stand-by online system 22.

In this connection, the communication media 50 and 51 may be physically combined into a single medium. However, for the purpose of preventing erroneous operation caused by a transfer delay of the control signal when the transfer traffic of the log information becomes high, the media are provided separately in the present embodiment.

The database I/O buffer 13, log I/O buffer 14, database I/O buffer 23, log I/O buffer 24 or log information receive buffer 25 may be single buffers, respectively. However, for the purpose of insuring the performance and reliability, buffering is carried out respectively with a plurality of buffers.

The log output processor 15 and log transfer processor 16 are shown in the active online system 12; and the trace processor 27 is shown in the stand-by online system 22 in FIG. 1. However, the active online system 12 and the stand-by online system 22 have the same components mounted therein and are different only in their behaviors demanded by their active or stand-by system.

Thus, after an error occurs in the host computer 10, transaction execution authority is switched to the host computer 20 to cause the stand-by online system 22 to start the transaction service, and the stand-by online system 22 becomes the active system. After the host computer recovers from the error, the online system 12 again becomes the stand-by online system.

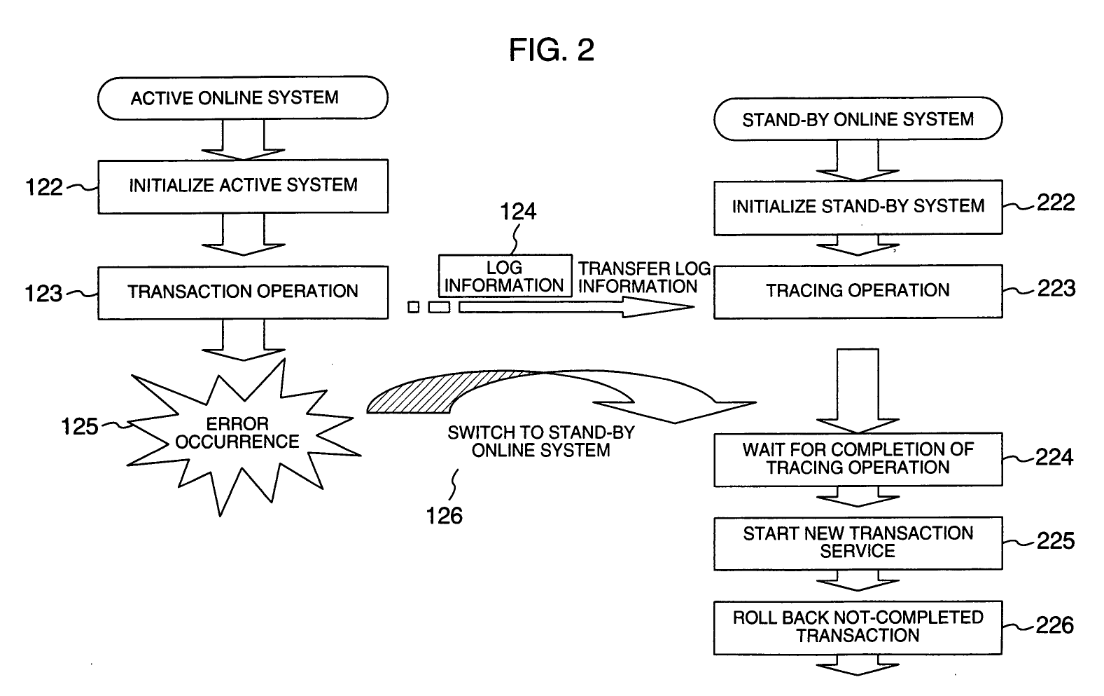

FIG. 2 is a flowchart for explaining a processing procedure of the active online system 12 and stand-by online system 22 in the present embodiment. As shown in FIG. 2, the active online system 12, after being started-up, first performs its initializing operation (step 122). Similarly, after start-up, the stand-by online system 22 performs its initializing operation (step 222).

In the initializing operation (22), the active online system 12 loads its processing program, inputs various definition information and execution parameters, creates a control table on a virtual memory, opens the database, starts a transaction execution space (also called the execution process), and further detects and stores the log information located at an end of the log file. In this example, the active online system 12 performs buffer securing, page fixing and buffer position information exchange in association with the log information transfer with the stand-by online system 22. In the online system, in addition to the above operations, establishment of a communication session with another terminal, changeover preparation, etc. are included. However, since these are outside the scope of the present embodiment, these are not illustrated in FIGS. 1 and 2.

The stand-by online system 22 performs an initializing operation similar to that of the active online system but as the stand-by system (step 222). At this point, mutual monitoring by the monitor processors 11 and 21 is started.

When the mutual monitoring is started, the active online system 12 performs a business transaction operation (step 123).

Log information 124 is acquired by the business transaction of the reference or update operation. This log information is transferred to the stand-by online system 22; and the stand-by online system 22 traces a transaction state in the memory or record reference and update states in the database according to the log information 124 (step 223). At this time, the log file 30 and the database 40 are updated by the active online system 12. Thus in the stand-by online system 22, the writing of the file and the database to the external storage is not carried out, and even the tracing of the index reference state or record update state of the database is carried out only on the database I/O buffer 23 in the memory.

When an error occurs in the active online system 12 (step 125), the monitor processor 11 or 21 detects the error and changes the execution authority of the business transaction to the stand-by online system 22 (step 126).

When the error is limited to the active online system 12 alone, the monitor processor 11 detects the error and informs the monitor processor 21. When the error spreads into the entire host computer 10 and even the monitor processor 11 cannot operate normally, the control message (alive message) from the monitor processor 11 to the monitor processor 21 is interrupted. Accordingly, the monitor processor 21 can spontaneously detect the error of the active online system 12.

When authority to execute as the active online system is switched to the stand-by online system 22, the system 22 waits for completion of the tracing operation of the log information 124 that may not yet have been processed (step 224); and then the system 22 starts a new business transaction service (step 225). Concurrently therewith, the system 22 rolls back the transaction not completed (step 226).

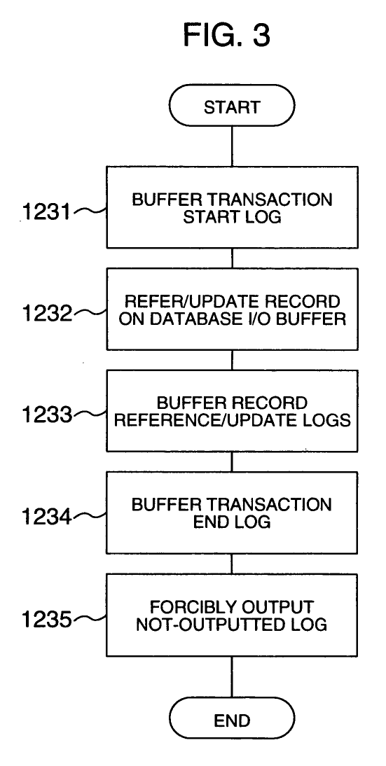

Shown in FIG. 3 is a flowchart for explaining processing of the business transaction operation in the present embodiment. Explanation will be made as to the business transaction operation of step 123 in FIG. 2, with reference here to FIG. 3.

When starting a transaction, the system buffers a transaction log, indicative of a start of the transaction in the log I/O buffer 14 (step 1231). Next, the system performs a record reference or update operation on the database I/O buffer 13 (step 1232). The system also buffers the record reference log and/or update log in the log I/O buffer 14 (step 1233). After completing the reference or update of the database record in the one transaction, the system buffers a transaction end log in the log I/O buffer 14 (step 1234) and forcibly outputs any log information not previously outputted to the log file 30 (step 1235).

When the system refers to data that is not present in the database I/O buffer 13 in the step 1232, the system may buffer its reference log in the log I/O buffer 14 in the step 1233 to lighten a load necessary for the output or transmission of the log information.

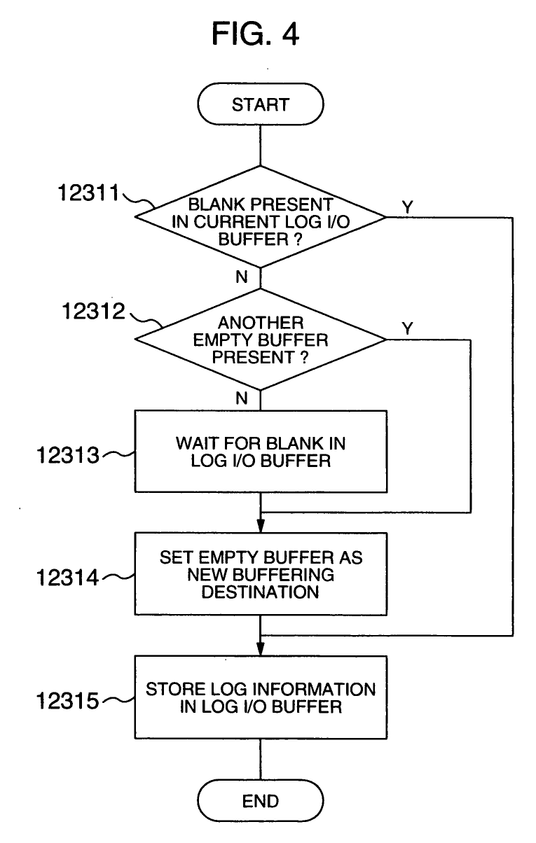

FIG. 4 is a flowchart for explaining processing of the buffering operation of the log information in the present embodiment. The buffering operation of the log information in the steps 1231, 1233 and 1234 of FIG. 3 will be explained by referring to FIG. 4.

The system first examines presence or absence of a blank area in the log I/O buffer, as the current buffering destination (step 12311). In the presence of a blank area, the system stores the log information in the log I/O buffer (step 12315).

In the absence of a blank area, the system examines presence or absence of a blank area in another log I/O buffer (step 12312). Upon finding a blank area, the system sets the log I/O buffer in question as its new buffering destination (step 12314), and it stores the log information in the blank area at that destination (step 12315).

Upon finding no single blank area in the log I/O buffer, the system, continues to wait for generation of a blank area in the buffer (step 12313). In this connection, when no single blank area is present in the log I/O buffer, there may be a method for dynamically securing a new log I/O buffer. However, since this causes a memory shortage and may trigger an error, this method will not be employed in the present embodiment.

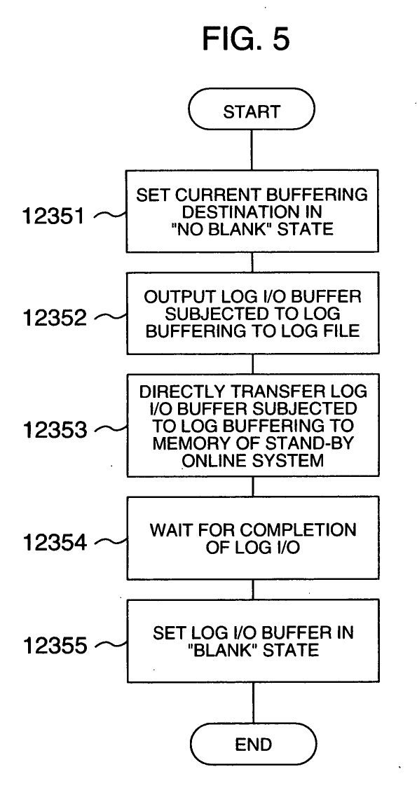

FIG. 5 is a flowchart for explaining processing of a forced output operation with respect to the log not previously outputted, in the present embodiment. Explanation will be made as to the forced output operation of the not-outputted log in the step 1235 in FIG. 3, by referring to FIG. 5.

The system first sets the log I/O buffer currently targeted as the buffering destination in a “no blank” state, to prevent new buffering to the log I/O buffer (step 12351).

Next, the system sequentially outputs information from log I/O buffers that have not outputted yet, to the log file 30 (step 12352). The output may be based on a synchronous write scheme wherein control is not returned until I/O operation to an external storage is completed, or on an asynchronous write scheme wherein control is returned before I/O operation is completed. In the present embodiment, for the purpose of minimizing the influence of the transfer operation of the log information to the stand-by online system 22 on the transaction of the active online system 12, the asynchronous write scheme is employed.

While waiting for completion of the writing operation in the log file 30, the system directly writes the contents of the log I/O buffer, obtained from the step 12352, into the log information receive buffer 25 of the stand-by online system 22 via the communication medium 51 (step 12353). Information, such as this write position, must be previously grasped at the time of initialization (122) and from return information at the time of previous transaction write operation (123).

When the stand-by online system 22 is not operated, the operation of the step 12353 will end unsuccessfully, but the active online system 12 treats it as if it had ended successfully. This mismatching can be solved when the system changes over to the stand-by online system 22, by reading a difference up to the latest log of the log information receive buffer 25 from the log file 30 and by catching up with it. As a result of this solving operation, even when changeover is frequently carried out between the active and stand-by systems, the system can automatically catch up.

Next the system waits for completion of the I/O operation of the step 12352 (step 12354). The system sets the log I/O buffer where both the operations of the steps 12352 and 12353 are completed as a blank buffer (step 12355).

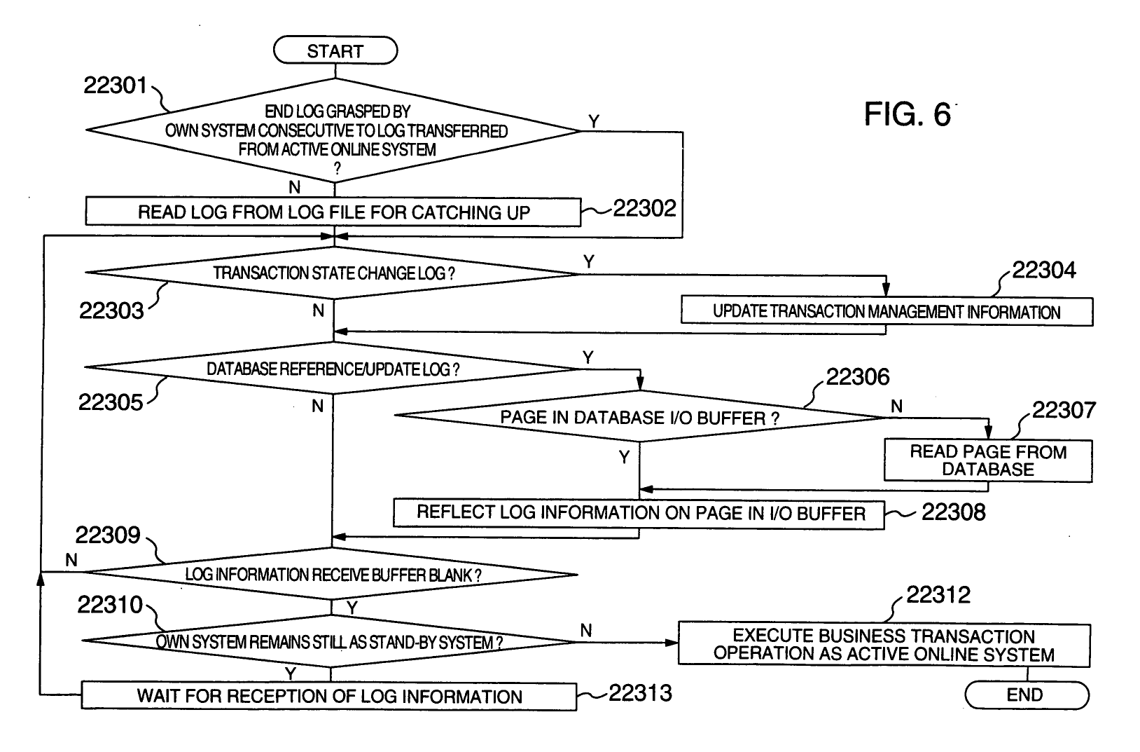

FIG. 6 is a flowchart for explaining processing of the tracing operation in the present embodiment. The tracing operation of the step 223 of FIG. 2 will be explained with reference to FIG. 6.

The system first compares log information at an end of the log file stored at the time of the initializing operation 222 of the stand-by online system 22 with log information sent to the log information receive buffer 25 (step 22301).

When the log information is discontinuous (when numbers as serial numbers of log blocks each as an assembly of generation number and log record of a log file are not consecutive and one block in the blocks is missing), the system inputs the log information 31 from the log file 30 to catch up with the time point of the log information receive buffer 25 (step 22302). A specific method for the catching-up operation is substantially the same as that in steps 22303 to 22308 to be explained later.

Next, the system sequentially examines individual log information stored in the log information receive buffer 25. When the log is that of a transaction start or end log where a change of the transaction state is recorded (step 22303), the system updates management information for each transaction in the memory (step 22304).

When the log is a database record reference or update log (step 22305), the system examines presence or absence of a corresponding page in the database I/O buffer 23 (step 22306). In the absence of the page of the record in the database I/O buffer 23, the system reads the record page into the database I/O buffer 23 from the database 40 (step 22307). When the log is an update log, the system updates the record on the database I/O buffer 23 according to the contents of the update log (step 22308).

The system repeats the operations of the steps 22303 to 22308 for all log information present in the log information receive buffer 25 (step 22309).

Subsequently, the system confirms whether or not there is an error detection by the monitor processor 11 or 21 and examines whether or not its own system still operates as the stand-by system (step 22310). If the system still operates as the stand-by system, then the system waits for reception of the log information (step 22313) and repeats the operations of the steps 22303 to 22308. When changeover to the active system is initiated by the error detection by the monitor processor 11 or 21, the system executes the business transaction operation as the active system (step 22312).

As has been explained above, in accordance with the online processing system of the present invention, when an error occurs in the active online system, the stand-by online system can continue the transaction operation with use of the I/O buffer of the stand-by online system, the contents of which having been previously made to coincide with the contents of the I/O buffer of the active online system. Thus, at the time of error occurrence in the active online system, changeover to the stand-by online system can be carried out at a high speed.

Further, in the online processing system of the present embodiment, when reference operation is carried out to data not present in the I/O buffer of the active online system, the system transfers the reference history to the stand-by online system as log information. As a result, the transfer load of the log information necessary to make the contents of the I/O buffer in the stand-by online system coincide with the contents of the I/O buffer in the active online system can be lightened.

In the online processing system of the present embodiment, in addition, when the log information subjected to the tracing operation is discontinuous to the log information transferred from the active online system, the system reads out discontinuous log information therebetween from the storage and performs the catch-up operation over the I/O buffer in the stand-by online system. Therefore, when the stand-by online system has an error or is re-activated after its maintenance, the system can again establish the hot stand-by state while not affecting the execution of the transaction operation of the active online system.

In accordance with the present invention, when an error occurs in the active online system, the system can continue the transaction operation of the stand-by online system with use of the I/O buffer of the stand-by online system, the contents of which were previously made to coincide with the contents of the I/O buffer of the active online system. As a result, when an error occurs in the active online system, changeover to the stand-by online system can be realized at a high speed.

It will be further understood by those skilled in the art that the foregoing description has been made on embodiments of the invention and that various changes and modifications may be made in the invention without departing from the spirit and scope the appended claims.

1-11. (canceled)

12. An online system recovery method in an online system having an active online system, a stand-by online system and a storage including a database accessible from the active and stand-by online systems, comprising steps of:
monitoring, in the stand-by online system, an operating state of a transaction operation in the active online system executing the transaction operation on data flowing through a first I/O buffer to or from the database so as to detect an error during the transaction operation by use of a first monitor of the active online system and a second monitor of the stand-by online system connected to each other;
transferring, from the active online system, first log information having both a reference history indicative of a history of reference operation carried out in the active online system and an update history indicative of a history of update operation carried out in the active online system to a log information receive buffer of the stand-by online system, to serve as second log information, when an error is detected during the transaction operation in the active online system;
carrying out changeover of execution between the active online system and the stand-by online system, when the error in the active online system is detected;
performing, in the stand-by online system, a tracing operation on the second log information to make contents of data in a second I/O buffer in the stand-by online system coincide with contents of data in the first I/O buffer of the active online system according to the second log information; and
causing the stand-by online system to continue the transaction operation, from a point corresponding to occurrence of the error by use of contents of the second I/O buffer, in place of the active online system.

13. An online system recovery method as set forth in claim 12, wherein the second log information in the log information receive buffer of the stand-by online system indicates a history of reference operation in the active online system referring to data for the transaction operation present in the first I/O buffer of the active online system.

14. An online system recovery method as set forth in claim 13, further comprising steps of:
storing, from the active online system, the reference history and the update history in the storage shared by the active and stand-by online systems; and
reading out the reference history and the update history from the storage to make contents of data in the second I/O buffer in the stand-by online system coincide with contents of data in the first I/O buffer of the active online system.

15. An online system recovery method as set forth in claim 12, further comprising steps of:
storing, from the active online system, the reference history and the update history in the storage shared by the active and stand-by online systems; and
reading out the reference history and the update history from the storage to make contents of data in the second I/O buffer in the stand-by online system coincide with contents of data in the first I/O buffer of the active online system.

16. An online recovery program embodied in at least one computer-readable medium and executable in an online system comprising an active online system, a stand-by online system and a storage including a database accessible from the active and stand-by online systems, for performing a sequence of steps comprising:
monitoring, in the stand-by online system, an operating state of a transaction operation in the active online system executing the transaction operation on data flowing through a first I/O buffer to or from the database so as to detect an error during the transaction operation by use of a first monitor of the active online system and a second monitor of the stand-by online system connected to each other;
transferring, from the active online system, first log information having both a reference history indicative of a history of reference operation carried out in the active online system and an update history indicative of a history of update operation carried out in the active online system to a log information receive buffer of the stand-by online system, to serve as second log information, when an error is detected during the transaction operation in the active online system;
carrying out changeover of execution between the active online system and the stand-by online system, when the error in the active online system is detected;
performing, in the stand-by online system, a tracing operation on the second log information to make contents of data in a second I/O buffer in the stand-by online system coincide with contents of data in the first I/O buffer of the active online system according to the second log information; and
causing the stand-by online system to continue the transaction operation, from a point corresponding to occurrence of the error by use of contents of the second I/O buffer, in place of the active online system.

17. An online recovery program as set forth in claim 16, wherein the second log information in the log information receive buffer of the stand-by online system indicates a history of reference operation in the active online system referring to data for the transaction operation present in the first I/O buffer of the active online system.

18. An online recovery program as set forth in claim 17, wherein the steps further comprise:
storing, from the active online system, the reference history and the update history in the storage shared by the active and stand-by online systems; and
reading out the reference history and the update history from the storage make contents of data in the second I/O buffer in the stand-by online system to coincide with contents of data in the first I/O buffer of the active online system.

19. An online recovery program as set forth in claim 16, wherein the steps further comprise:
storing, from the active online system, the reference history and the update history in the storage shared by the active and stand-by online systems; and
reading out the reference history and the update history from the storage to make contents of data in the second I/O buffer in the stand-by online system coincide with contents of data in the first I/O buffer of the active online system.

20. An online system comprising:
an active online system,
a stand-by online system, and
a storage including a database accessible from the active and stand-by online system, the active online system executing a transaction operation on data flowing through a first I/O buffer to or from the database so as to detect an error during the transaction operation by use of a first monitor of the active online system and a second monitor of the stand-by online system connected each other;
the active online system transferring first log information having both a reference history indicative of a history of reference operation carried out in the active online system and an update history indicative of a history of update operation carried out in the active online system to a log information receive buffer of the stand-by online system, to serve as second log information, when an error is detected during the transaction operation in the active online system;
the active and stand-by online systems carrying out changeover of execution between the active online system and the stand-by online system, when the error in the active online system is detected; and
the stand-by online system performing a tracing operation on the second log information to make contents of data in a second I/O buffer in the stand-by online system coincide with contents of data in the first I/O buffer of the active online system according to the second log information;
wherein the stand-by online system continues the transaction operation from a point corresponding to occurrence of the error by use of contents of the second I/O buffer, in place of the active online system.

21. An online system as set forth in claim 20, wherein the second log information in the log information receive buffer of the stand-by online system indicates a history of reference operation in the active online system referring to data for the transaction operation present in the first I/O buffer of the active online system.

22. An online system as set forth in claim 21, wherein:
the active online system stores the reference history and the update history in the storage shared by the active and stand-by online systems; and
the stand-by online system reads out the reference history and the update history from the storage to make contents of data in the second I/O buffer in the stand-by online system coincide with contents of data in the first I/O buffer of the active online system.

23. An online system as set forth in claim 20, wherein:
the active online system stores the reference history and the update history in the storage shared by the active and stand-by online systems; and
the stand-by online system reads out the reference history and the update history from the storage to make contents of data in the second I/O buffer in the stand-by online system coincide with contents of data in the first I/O buffer of the active online system.
